(19) United States
(12) Patent Application Publication
(10) Pub. No.: US 2014/0180466 A1
(43) Pub. Date: Jun. 26, 2014

(54) NUMERICAL CONTROL APPARATUS

(71) Applicants: Kenji Kato, Chiyoda-ku (JP); Masakazu Sagasaki, Chiyoda-ku (JP)

(72) Inventors: Kenji Kato, Chiyoda-ku (JP); Masakazu Sagasaki, Chiyoda-ku (JP)

(73) Assignee: MITSUBISHI ELECTRIC CORPORATION, Chiyoda-ku, Tokyo (JP)

(21) Appl. No.: 14/131,358

(22) PCT Filed: Jul. 13, 2011
(86) PCT No.: PCT/JP2011/003998

§ 371 Date: Feb. 7, 2014

(51) Int. Cl. G05B 19/18

(52) U.S. Cl. CPC G05B 19/18
USPC 700/174

(57) ABSTRACT

Devices, which correspond to I/O control signals that respectively control peripheral devices (114), and power consumptions of the peripheral devices are previously registered as parameters (103), and a state monitoring section (110) monitors whether I/O control signals are in on-state, and calculates an operating time, and a power amount calculating unit (111) calculates a power consumption amount of the peripheral device concerned on the basis of the operating time and the power consumption. Furthermore, the state monitoring section (110) has a function of, after machining is completed, forcibly stopping a peripheral device if there is a peripheral device that does not stop even after a predetermined time or after exceeding a predetermined power consumption amount, so that unnecessary power consumptions can be reduced.

### TECHNICAL FIELD

The invention relates to a numerical control (hereinafter referred to as NC) apparatus including a means to calculate a power consumption amount, and more particularly to a calculation of a power consumption amount on peripheral devices constituting a machine tool controlled by an NC apparatus.

### BACKGROUND ART

As a control apparatus for calculating a power consumption amount for an entire machine including peripheral devices, apparatus including a means for determining a power consumption amount for a peripheral device based on the product of an energization time and a power consumption of the device concerned has been proposed (for example, refer to Patent Document 1).

Similarly, as a control apparatus for calculating a power consumption amount for an entire machine including peripheral devices, an apparatus including a means for obtaining power consumption amounts of peripheral devices by using information taken into a control apparatus in advance to sum up power consumptions while the devices are in the on-state, has been proposed (for example, refer to Patent Document 2).

### PRIOR ART DOCUMENT

### Patent Document

Patent Document 1: Japanese Patent Application Laid-open No. 2000-206150

Patent Document 2: Japanese Patent Application Laid-open No. 2010-115063

### DISCLOSURE OF THE INVENTION

### Problems to be Solved by the Invention

By the way, in the former example of the conventional control apparatus described above, a problem arises in that since there is no means to identify an operational state of a peripheral device, a means to identify an operational state has to be newly provided.

In addition, in the latter example of the conventional control apparatus described above, there remains a problem that an accurate power consumption in accordance with an actual operational situation of a peripheral device cannot be calculated.

Moreover, in the conventional control apparatus as described above, there is a problem that an unnecessary power consumption cannot be reduced although a power consumption for a peripheral device can be calculated.

The present invention is accomplished to solve such problems, and a purpose thereof is to realize an NC apparatus in which a power consumption amount for a peripheral device is accurately calculated without installing an external device.

Another purpose of the invention is to realize an NC apparatus which can stop the operation of a peripheral device when there exists a peripheral device consuming power wastefully.

### Means for Solving the Problems

A numerical control apparatus according to the invention includes: a storage means which stores power consumptions of peripheral devices constituting a machine tool; a state monitoring means which identifies operational states of the peripheral devices by monitoring state changes of I/O control signals or auxiliary commands which control the peripheral devices; and a power calculation means which calculates power consumption amounts for peripheral devices based on signals from the state monitoring means and power consumptions of peripheral devices stored in the storage means.

In addition, a numerical control apparatus according to the invention includes a function in which the state monitoring means judges whether a peripheral device is stopped or not after machining is completed, and makes a PCL processing unit output a signal to stop the peripheral device if the peripheral device is not stopped.

### Effect of the Invention

According to this invention, a power consumption amount is calculated based on a state change of an I/O control signal and an auxiliary command which are essential to an NC apparatus, so that a power consumption amount can be calculated without adding devices or wiring, and consequently without increasing a cost largely.

Furthermore, according to this invention, a peripheral device is forcibly stopped even in the case where a peripheral device is not turned off after machining is completed, so that an unnecessary power consumption amount can be reduced.

### BRIEF DESCRIPTION OF THE DRAWINGS

FIG. 1 is a block diagram showing a configuration of an NC apparatus according to Embodiment 1 of the invention.

FIG. 2 is a diagram showing an example of a machining program according to Embodiment 1 of the invention.

FIG. 3 is a diagram showing an example of parameter setting according to Embodiment 1 of the invention.

FIG. 4 is a flow chart showing an operation of a state monitoring section according to Embodiment 1 of the invention.

### BEST MODE FOR CARRYING OUT THE INVENTION

### Embodiment 1

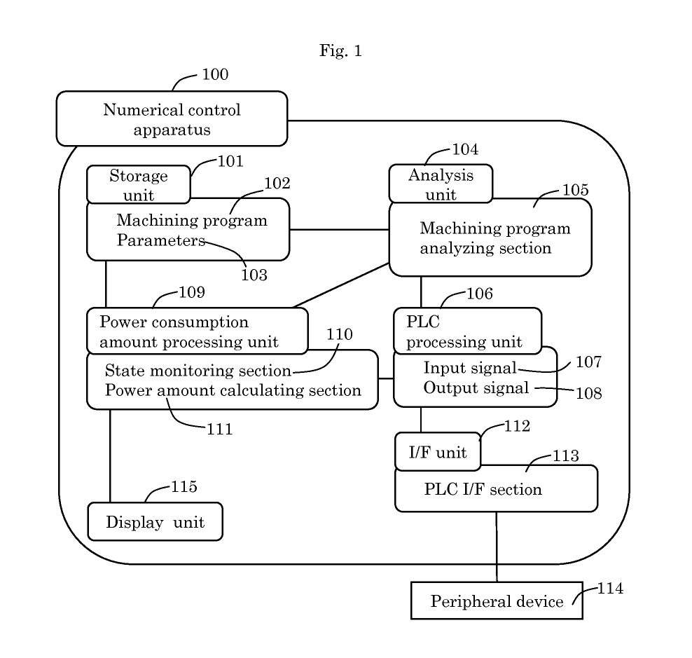

Hereinafter Embodiment 1 of the invention will be explained using FIGS. 1 through 4. FIG. 1 is a block diagram showing a configuration of an NC apparatus 100 according to Embodiment 1 of the invention. The NC apparatus 100, which controls the operation of a machine tool (not shown in the figure) and peripheral devices 114 in accordance with the contents of a machining program 102 to be inputted, is configured with a storage unit 101, an analyzer unit 104, a PLC (programmable logic controller) processing unit 106, a power consumption amount processing unit 109, an I/F (interface) unit 112, and a display unit 115. Incidentally, the hardware configuration of the NC apparatus 100 is the same with a general NC apparatus which is configured with a CPU, a memory and the like. And the analyzer unit 104, the power consumption amount processing unit 109 and the like are comprised of software.

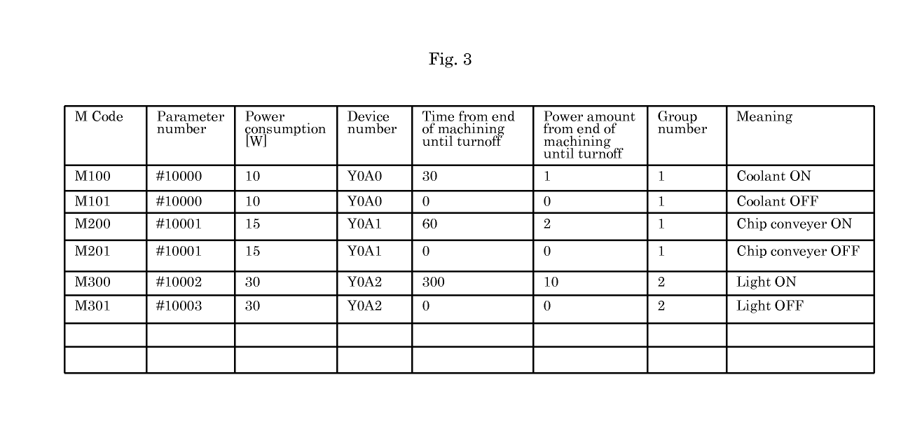

The storage unit 101 stores a machining program 102, parameters 103 shown in FIG. 3, etc. Further, in the parameters 103 shown in FIG. 3, corresponding to an M code (auxiliary command) for controlling a peripheral device (coolant, chip conveyor, light, etc.) for which a power amount needs to be calculated, a parameter number, a power consumption, a device number corresponding to an I/O (input/output) control signal, a time from the end of machining until the turnoff, a power amount from the end of machining until the turnoff, a group number, and a meaning of M code are set by an input means which is not shown in the figures. In addition, the analyzer unit 104 for analyzing and executing the machining program 102 includes a machining program analyzing section 105 which loads, analyzes and executes the machining program 102 stored in the storage unit 101, and inform a PLC processing unit 106 of an execution state of the machining program in accordance with an analysis and an execution result (in the case where the analysis result of the machining program is an auxiliary command, the PLC processing unit 106 is made to execute the auxiliary command).

The PLC processing unit 106 has a function of processing a sequence program which controls the machine operation and the peripheral devices 114, and controls the peripheral devices 114 by turning on and off the I/O control signal (an input signal 107, an output signal 108) based on the notification on the execution state of the machining program (auxiliary command notification) from the machining program analyzing section 105. A PLC I/F section 113 of the I/F unit 112 has a function of exchanging signals with the PLC processing unit 106 and the peripheral devices 114, and inputs the I/O control signal outputted from the PLC processing unit 106 to the peripheral devices 114, and conversely, inputs the operational state signals of the peripheral devices 114 to the PLC processing unit 106.

The state monitoring section 110 in the power consumption amount processing unit 109 has a function of monitoring I/O control signals of the PLC processing unit 106 which are set in the parameters 103, and calculates the operating time when there are running peripheral devices 114, and also has a function of stopping the peripheral devices 114 through the PLC processing unit 106 if they are running after machining is completed. A power amount calculating section 111 in the power consumption amount processing unit 109 has a function of calculating power consumptions of the peripheral devices 114 based on the operating time calculated in the state monitoring section 110 and a consumption power (W) set in the parameters 103, and also carries out processing to sum up the calculated power consumptions for each group set in the parameters 103. The display unit 115 has a function of displaying the power consumptions obtained by the power consumption amount processing unit 109, and displays the power consumption amount of the entire machine and the power consumption amount for each group.

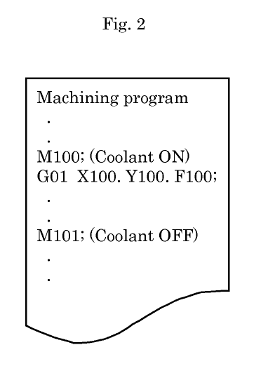

Next, an operation of a NC apparatus according to Embodiment 1 in the invention will be explained. Namely, the program analyzing section 105 loads the machining program 102 from the storage unit 101, and analyzes it. For example, when the machining program 102 shown in FIG. 2 is analyzed, the PLC processing unit 106 is firstly notified of the fact that M100 being an auxiliary command (discharge command of a cutting fluid (coolant) needed for machining) is issued. The PLC processing unit 106 processes a sequence program for controlling the machine operation and the peripheral devices 114, and when M100 is analyzed in the program analyzing section 105, the PLC processing unit 106 outputs an I/O control signal for discharging a cutting fluid to the PLC-I/F section 113. The PLC-I/F section 113 has a function of exchanging signals with the PLC processing unit 106 and the peripheral devices 114. The PLC-I/F section 113 notifies a peripheral device 114 of an I/O control signal from the PLC processing unit 106. Consequently, a cutting fluid is discharged in the peripheral device 114. Further, when discharge of the cutting fluid is started in the peripheral device 114, the peripheral device 114 notifies the PLC-I/F section 113 of the state where the cutting fluid is being discharged as a signal.

The PLC processing unit 106, after receiving an operational state signal of the peripheral device 114 from the PLC-I/F section 113, notifies the machining program analyzing section 105 of the fact that the discharge of the cutting fluid is started. An interpolation processing unit (not illustrated), which receives the fact from the machining program analyzing section 105, executes (interpolates) the next block process (G01 X100. Y100. F100;), and then the result is outputted through a smoothing unit and an output unit, which are known and not illustrated, to a servo control unit, so that a servo motor is driven and machining is started.

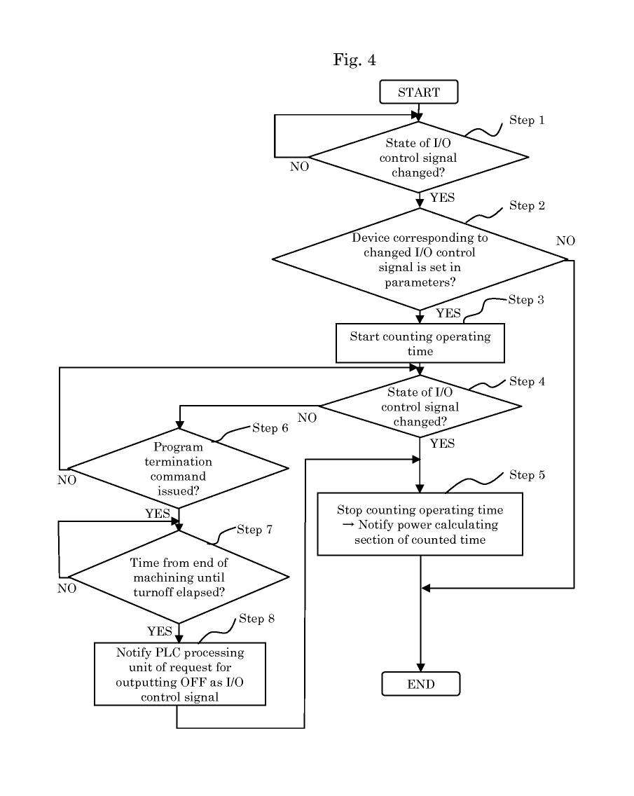

The state monitoring section 110 in the power consumption amount processing unit 109 is operated as shown in FIG. 4. Namely, the state monitoring section 110 in Step 1 monitors I/O control signals of the PLC processing unit 106, and when the state in an I/O control signal is changed (for example, when Y0A0 is turned on), the process proceeds to Step 2, and whether or not the device corresponding to the changed I/O control signal is set in the parameters 103 is judged, and if the device is not set, the process is terminated. If the device is set, the process proceeds to Step 3, and counting of the operating time of the peripheral device 114 corresponding to the I/O control device is started, and the process proceeds to Step 4.

In Step 4, whether there is a state change of the I/O control signal or not is monitored, and when there is no change in the state of the I/O control signal, the process proceeds to Step 6, and whether there is a program termination command (for example, M02 command) or not is monitored. When there is no program termination command, the process is moved back to Step 4, and whether there is a state change of the I/O control signal or not is monitored. When there is a state change in the I/O control signal in Step 4, for example, M101 command (discharge termination (coolant off) command) shown in FIG. 2 is executed, the process proceeds to Step 5, and counting of the operating time is stopped, and the power amount calculating section 111 is notified of the counted operating time. In addition, when there is a program termination command (for example, M02 command) in Step 6, the process proceeds to Step 7. Incidentally, the case where the process proceeds to Step 7 occurs when a program termination command (for example M02 command) is issued although M101 command is not written due to M101 (coolant off command) command left forgotten to be written during programming.

In Step 7, a predetermined time from the end of machining (reading of a program termination command) until the turnoff is read from among the parameters 103, and whether the time elapses or not is judged. And when the time elapses, the process proceeds to Step 8. In Step 8, the PLC processing unit 106 is notified of a request for outputting an OFF signal as the I/O control signal, and the process proceeds to Step 5. The state monitoring section 110 functions as described above. Incidentally, the PLC processing unit 106, which has been notified of the request from the state monitoring section 110 for outputting an OFF signal as the I/O control signal, outputs an I/O control signal through the I/F unit 112 for stopping a peripheral device 114. In the machining program shown in FIG. 2, for example, even in a state in which M101 (coolant on) command is stated, but M102 (coolant off) command is not stated (left forgotten to be written), and the coolant is being discharged after machining is completed, the discharge of the coolant is terminated after the predetermined time elapses.

Further, the power amount calculating section 111, which is notified of the counted operating time from the state monitoring section 110, reads from among the parameters 103 the power consumption (W) corresponding to the device (I/O control signal) for which the operating time is notified, and obtains a power consumption amount for each peripheral device by calculating the power consumption (W) x the operating time, and then stores the result in the storage unit 101. Furthermore, referring to the group numbers stored in the parameters 103, it sums up the power consumption amounts for the same group. In addition, by correlating the calculated power consumption amount of each peripheral device with the sequence number of the machining program, the power amount calculating section 111 can also display how the power consumption amount for each peripheral device changes as the machining program is executed. The display unit 115 has a function of displaying the power consumption amount obtained by the power consumption amount processing unit 109. For example, it can display the power consumption amount for the entire machine or on a group basis.

As described above, according to Embodiment 1, by monitoring the state change of the I/O control signal which is essential for a NC apparatus, a power consumption amount for a peripheral device can be obtained in accordance with a machining situation. Also in Embodiment1, because the change in the I/O control signal is monitored, the measurement of the power consumption amount is possible on a peripheral device which is activated by a button on an operation board of the machine or the like other than a machining program. In addition, because a function of forcibly turning off a peripheral device which is running for a certain period after execution of the machining program is terminated, is provided, the peripheral device can be forcibly stopped, for example, in a situation in which, after execution of the machining program is stopped, a peripheral device is not turned off after exceeding the time from the end of machining until the turnoff, or after exceeding the power consumption amount from the end of machining until the turnoff, both of which are set in the parameters. Thus, according to an NC apparatus of Embodiment1, using an I/O control signal which is essential for an NC apparatus, a power consumption amount for a peripheral device can be accurately calculated in accordance with an operational situation, and also an unnecessary power consumption amount can be reduced.

Incidentally, in Embodiment 1 as described above, the state monitoring section 110 in the power consumption amount processing unit 109 monitors the I/O control signal (monitoring the device state change corresponding to the I/O control signal) of the PLC processing unit 106 so that a power consumption amount of a peripheral device which is activated by a button on an operation board of a machine or the like can be measured. However, it is not particularly limited to this method, but by monitoring the change of an M code, counting the operating time of a peripheral device can be started and stopped. Moreover, in Embodiment 1 as described above, in Step 7 of FIG. 4, the time from the end of machining until the turnoff, which is set in the parameters 103, is read out, and the judgment is made on whether the time elapses or not. However, it may be configured in such a way that the power amount from the end of machining until the turnoff, which is set in the parameters 103, is read out, and the PLC processing unit 106 is notified of the request for outputting OFF as an I/O control signal based on the judgment whether the power amount is exceeded or not. In addition, in Embodiment 1 described above, although the explanation is based on a case in which both the time from the end of machining until the turnoff and the power amount from the end of machining until the turnoff are set in the parameters 103, it goes without saying that the initial objective will be achieved by setting either of them.

### INDUSTRIAL APPLICABILITY

A numerical control apparatus according to the invention is suitable for calculating a power consumption amount for a peripheral device.

### EXPLANATION OF REFERENCE NUMERALS

100: Numerical control apparatus, 101: Storage unit, 102: Machining program, 103: Parameters, 104: Analyzer unit, 105: Machining program analyzing section, 106: PLC processing unit, 107: Input signal, 108: Output signal, 109: Power consumption amount processing unit, 110: State monitoring section, 111: Power amount calculating section, 112: I/F unit, 113: PLC-I/F section, 114: Peripheral device, 115: Display unit.

1-3. (canceled)

4. A numerical control apparatus comprising:
a storage which stores a power consumption amount from an end of machining unit turnoff of a peripheral device constituting a machine tool; and
a state monitoring means which identifies operational state of the peripheral device by monitoring state change of I/O control signal or auxiliary command for controlling the peripheral device, and which automatically makes a PLC processing unit to output a signal to stop the peripheral device in a case after machining is completed where the peripheral device is not stopped even after exceeding the power consumption amount from the end of machining until the turnoff, which is stored in the storage.
